(19) United States
(12) Patent Application Publication
(10) Pub. No.: US 2019/0156357 A1
(43) Pub. Date: May 23, 2019

(54) ADVANCED COMPUTATIONAL PREDICTION MODELS FOR HETEROGENEOUS DATA

(71) Applicant: Staples, Inc., Framingham, MA (US)

(72) Inventors: Evangelos Palinginis, Natick, MA (US); Nitin Verma, Natick, MA (US); Michael Bhaskaran, Sherborn, WA (US); Jian Jiao, Jersey City, NJ (US)

(21) Appl. No.: 16/169,923

(22) Filed: Oct. 24, 2018

Related U.S. Application Data
(60) Provisional application No. 62/590,137, filed on Nov. 22, 2017.

(51) Int. Cl. G06Q 30/02; G06F 17/18; G06K 9/62

(52) U.S. Cl. CPC G06Q 30/0202; G06K 9/6218; G06F 17/18; G06Q 30/0201

(57) ABSTRACT

In an example embodiment, systems and methods are described for demand prediction and profitability modeling based on heterogeneous data and blended clustering models. Data for a plurality of items is received and differentiated into a first set of good items and a second set of bad items. Good items and bad items may be indicated by a threshold for a prediction accuracy metric, such as weighted Mean Average Percentage Error (MAPE). A first model for predicted demand levels of the good items is generated that excludes cross-cluster effects with the bad items. A second model of the bad items is generated that includes a residual correction and cross-cluster effects with the good items. A predicted demand of a particular item is generated based on a cluster-level regression model and at least one of the first model and the second model.

### BACKGROUND

The present disclosure generally relates to demand forecasting using regression models. In a more particular example, the present disclosure relates to using blended prediction models.

Large retailers may manage thousands of different items across multiple geographic locations and channels, such as online, retail stores, mail and/or telephone catalog sales, etc. These items may be tracked by unique product identifiers, such as stock keeping units (SKUs), and managed through a complex supply chain that includes vendors (such as product manufacturers and distributors), distribution centers (DCs), fulfillment centers (FCs), and retail locations. Computerized point-of-sale, affinity program, web and mobile application, customer relationship management (CRM), inventory control, supply chain management, and related financial systems generate volumes of product and sales data tied to product SKUs.

Promotions, such as discounts, bundles, demonstrations/displays, events, campaigns, etc., may have both direct and indirect impacts on the time, location, volume, and, ultimately, profitability of product sales. Given diverse product portfolios, the clustering and interrelation of different products, and the importance of successful deployment of promotional strategies, some retailers have begun using data mining and computer modeling to predict demand and the performance of promotions for retail (and wholesale) products.

These demand modeling systems may rely on regression modeling that clusters SKUs based on various features and relationships to quantify various profitability factors. In some cases, the sales data used for the demand modeling may be heterogeneous across SKUs, meaning that some SKUs have higher quality data than other SKUs. This heterogeneous data, particularly data with low prediction accuracy, may skew modeled demand and related profitability factors in a way that decreases the overall accuracy and robustness of the model. While a variety of clustering algorithms have been developed and applied to demand modeling, there is an ongoing need to refine these models to improve prediction accuracy and robustness to improve promotion planning.

### SUMMARY

According to innovative aspects of the subject matter described in this disclosure, systems, methods, and other aspects for blended modeling of demand prediction are presented.

According to one innovative aspect of the subject matter described in the disclosure, a method is executable by one or more computing devices to receive data for a plurality of items. A first set of items of the plurality of items is differentiated from a second set of items of the plurality of items based on the data. The first set of items has good data and the second set of items has bad data. Good data is indicated by a prediction accuracy metric of the good data being below a threshold. Bad data is indicated by the prediction accuracy metric of the bad data being above the threshold. A first model is generated for predicted demand levels of the first set of items. The first model excludes cross-cluster effects with the second set of items. A second model is generated for predicted demand levels of the second set of items. The second model includes a residual correction. At least one cluster-level regression model is fitted to estimate model coefficients associated with the first model and the second model. A predicted demand of a particular item of the plurality of items is generated based on the at least one cluster-level regression model and at least one of the first model and the second model.

According to some innovative aspects of the subject matter, receiving data for the plurality of items may comprise receiving a sales vector for the plurality of items over a defined period of time and receiving a matrix of item features for the plurality of items over the defined period of time. Differentiating the first set of items from the second set of items based on the data may comprise using a decentralized model to calculate weighted mean average percentage error values for the plurality of items at item-level as the prediction accuracy metric. The plurality of items may be clustered using a clustering algorithm to assign the plurality of items to a plurality of item clusters. In-cluster indicators may be generated for the plurality of items in each of the plurality of item clusters. Cross-cluster indicators may be generated for the plurality of items in each of the plurality of item clusters.

According to additional innovative aspects of the subject matter, generating the first model may comprise selectively removing at least one term that includes cross cluster effects and fitting at least one item-level correction model for the first set of items. Generating the second model may include fitting at least one item-level correction model for the second set of items. The at least one item-level correction model includes in-cluster features.

According to other innovative aspects of the subject matter, generating the first model may comprises using a decentralized model to calculate prediction accuracy metric values for the plurality of items at item-level. Fitting at least one cluster-level regression model may comprises selectively removing at least one term that includes cross cluster effects. Generating the second model may include fitting at least one item-level correction model for the second set of items, wherein the at least one item-level correction model includes in-cluster features. The first model, the second model, and the at least one cluster-level regression model include a plurality of coefficients estimated through regression-based fitting. Generating the predicted demand of the particular item of the plurality of items may comprises recovering the plurality of coefficients estimated for the particular item and calculating a predication accuracy value for the particular item.

According to still other innovative aspects of the subject matter, a proposed promotion associated with the particular item from the plurality of items may be received. The predicted demand of the particular item may be displayed on a graphical user interface. Displaying the predicted demand of the particular item for the proposed promotion may include displaying a profitability value associated with the proposed promotion over a defined period of time. Displaying the predicted demand of the particular item for the proposed promotion may include displaying at least one profitability factor including baseline, uplift, discount, vendor fund, cannibalization, pull forward, halo effect, or total increase.

According to another innovative aspect of the subject matter described in the disclosure, a system comprises at least one processor, at least one memory, and a sales data source comprising data for a plurality of items. A clustering analysis engine is stored in the memory and executable by the processor for various operations. The clustering analysis engine differentiates a first set of items of the plurality of items from a second set of items of the plurality of items based on the data. The first set of items has good data and the second set of items has bad data. Good data is indicated by a prediction accuracy metric of the good data being below a threshold. Bad data is indicated by the prediction accuracy metric of the bad data being above the threshold. The clustering analysis engine generates a first model for predicted demand levels of the first set of items. The first model excludes cross-cluster effects with the second set of items. The clustering analysis engine generates a second model for predicted demand levels of the second set of items. The second model includes a residual correction. The clustering analysis engine fits at least one cluster-level regression model to estimate model coefficients associated with the first model and the second model. The clustering analysis engine generates a predicted demand of a particular item of the plurality of items based on the at least one cluster-level regression model and at least one of the first model and the second model.

According to some innovative aspects of the subject, the clustering analysis engine may generate a sales vector for the plurality of items over a defined period of time and a matrix of item features for the plurality of items over the defined period of time. The clustering analysis engine may use the sales vector and the matrix of item feature to generate the first model and the second model. The clustering analysis engine may use a decentralized model to calculate waited mean average percentage error values for the plurality of items at item-level as the prediction accuracy metric used to differentiate the first set of items from the second set of items. The clustering analysis engine may cluster the plurality of items using a clustering algorithm to assign the plurality of items to a plurality of item clusters. The cluster analysis engine may generate in-cluster indicators for the plurality of items in each of the plurality of item clusters and cross-cluster indicators for the plurality of items in each of the plurality of item clusters.

According to additional innovative aspects of the subject matter, the clustering analysis engine may generate the first model by selectively removing at least one term that includes cross cluster effects and fitting at least one item-level correction model for the first set of items. The clustering analysis engine may generate the second model by fitting at least one item-level correction model for the second set of items. The at least one item-level correction model may include in-cluster features.

According to other innovative aspects of the subject matter, the clustering analysis engine may generate the first model using a decentralized model to calculate prediction accuracy metric values for the plurality of items at item-level. The clustering analysis engine may fit at least one cluster-level regression model by selectively removing at least one term that includes cross cluster effects. The clustering analysis engine may generate the second model by fitting at least one item-level correction model for the second set of items. The at least one item-level correction model may include in-cluster features. The first model, the second model, and the at least one cluster-level regression model may include a plurality of coefficients estimated through regression-based fitting. The clustering analysis engine may generate the predicted demand of the particular item of the plurality of items by recovering the plurality of coefficients estimated for the particular item and calculating a predication accuracy value for the particular item.

According to still other innovative aspects of the subject matter, the system may include an input device and an output device. A proposed promotion associated with the particular item from the plurality of items may be input through the input device. The output device may be configured to display the predicted demand of the particular item on a graphical user interface. The predicted demand displayed on the graphical user interface may include a profitability value associated with the proposed promotion over a defined period of time. The predicted demand displayed on the graphical user interface may include at least one profitability factor including baseline, uplift, discount, vendor fund, cannibalization, pull forward, halo effect, or total increase.

According to still another innovative aspect of the subject matter described in the disclosure, a method is executable by one or more computing devices to receive data for a plurality of items. A first set of items of the plurality of items is differentiated from a second set of items of the plurality of items based on the data. The first set of items has good data and the second set of items has bad data. Good data is indicated by a prediction accuracy metric of the data being below a threshold. Bad data is indicated by the prediction accuracy metric of the data being above the threshold. A model is generated for determining a predicted demand level of at least one item of the second set of items using the good data for the first set of items. A cluster-level demand model of the one or more items is fit using item-level attributes shared by one or more of the plurality of items. A predicted demand of a particular item of the plurality of items is generated based on the cluster-level demand model.

The various embodiments advantageously apply the teachings of demand modeling systems to improve the functionality of such computer systems. The various embodiments include operations to overcome or at least reduce the issues in the previous demand modeling systems discussed above and, accordingly, are more accurate and robust than other computer modeling architectures for some applications, such as promotion modeling. That is, the various embodiments disclosed herein include hardware and/or software with functionality to improve accuracy and robustness of demand modeling systems, based on identifying and compensating for heterogeneous sales data in the generation of predicted demand values.

It should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example and not by way of limitation in the figures of the accompanying drawings, in which like reference numerals are used to refer to similar elements.

FIG. 1 is a flowchart of an example method for selecting and refining a prediction model in accordance with some embodiments of the disclosure.

FIG. 2 is a flowchart of an example method for computing blended models in accordance with some embodiments of the disclosure.

FIG. 3 is a flowchart of another example method for computing blended models in accordance with some embodiments of the disclosure.

FIG. 4 is a flowchart of another example method for computing blended models in accordance with some embodiments of the disclosure.

FIGS. 5A and 5B are a graphical representation of an example graphical user interface for selecting and refining a prediction model in accordance with some embodiments of the disclosure.

FIG. 6 is a block diagram of an example computing system in accordance with some embodiments of the disclosure.

FIG. 7 is a block diagram of an example system in accordance with some embodiments of the disclosure.

FIG. 8 is a listing of regression equations in accordance with some example embodiments of the disclosure.

FIG. 9 is a table of example predicted demand equations in accordance with some example embodiments of the disclosure.

### DETAILED DESCRIPTION

The implementation of the blended computational prediction models for heterogeneous data may yield significant impact to the promotion planning, the supply chain, and the merchandising groups in any environment.

First, the robustness of algorithms described herein may permit more accurate promotion planning based on the vector of attributes of stock keeping units (SKUs) with similar behavioral patterns. Precise number of units sold at the SKU level may be an important factor in decision strategy since it allows for better prediction of the total margin. Subsequently, the accurate estimation of the margin allows for better distribution of funding towards further horizontal and vertical expansion of investments.

Second, the impact on a supply chain may be significant. The vast majority of costs associated with supply chain are the transportation costs, the holding costs, and obsolescence costs. Assuming pre-existing locations for fulfillment centers (FCs) and distribution centers (DCs), the transportation cost may be a function of the fleet size and of the capacity constraints given time intervals. A more accurate prediction of promotions allows for better planning for deliveries and thus for increased reliability of the company on our customers' eyes. Additionally, obsolescence and holding costs may be minimized because the difference between the expected number of units to be sold and the actual number of units sold due to a planned promotion is reduced. Therefore, the problem of overstocking may be reduced; capacity issues at DCs and FCs may be alleviated; the SKUs may be at lower risk of becoming obsolete; and the saved amount of dollars can be reinvested to other projects. Going beyond the aforementioned, the system may make decisions on how to adjust order fulfillment logic that involves, among others, the placement of FCs and DCs, the layout of the FCs, labor needs and more.

Third, the blended models may permit redesign of decision-making processes. There may be competitive advantage in the expansion of the variety of commodities that belong to different groups of products. There are two types of those commodities: products that are just introduced to the market (for instance, the latest model smartphone in the time period around its launch); or commodities that are already available from competitors. The similar pattern of the above two types of commodities is the underlying uncertainty in terms of their sales behavior once they are introduced to availability in the system. Given the above, a computation of the units to be sold as baseline and the generated uplift from promotions may prompt better allocation of funding and space (this is a binary decision on either stocking or drop-shipping a SKU), but may also be used to set the milestones for maximizing margins given price competitiveness.

The technology disclosed herein includes computing systems, methods, user interfaces, data, and other aspects that determine and implement clustering-based demand forecasting algorithms. Some implementations of the technologies may consider, at a department level (e.g., electronics, laptops, office products, etc.), or other division, a class of SKUs, fix certain parameters at certain hierarchies, and interpret other signals at lower hierarchies. The technologies may differentiate SKUs with sufficient or good data from those with insufficient or bad data. A model may then be refitted to match the signals from the SKUs with good data and apply them to the SKUs with bad data while keeping the models for the SKUs with good data intact. These and other features and processes are described in further detail below.

Implementations of the technology described herein are beneficial in improving demand prediction accuracy in heterogeneous concentrations of sufficient and sparse data, thereby improving bandwidth adjustment, resource assignment, and even, in some implementations, allowing graphical user interfaces to be specifically adjusted based on demand. For instance, some computing devices have limited size displays that can display only a limited number of graphical elements (e.g., which may correspond to SKUs in varying amounts of demand). The technology described herein may automatically and dynamically format a graphical user interface to display only those graphical elements (or otherwise arrange or size the graphical elements) based on the predicted demand. For example, the technology may automatically surface the top X rows of graphical elements in a displayable (e.g., based on screen or displayable area size) graphical region based on the forecasted demand of each item corresponding to the graphical elements.

The technology described herein may predict baseline and promotion demand of data, objects, or other items represented by SKUs with hierarchical structures. Items may refer to digital or tangible objects capable of embodying a product or service. Items may be grouped and/or arranged in hierarchies and, in some cases, an item may itself correspond to a set of other items. In some embodiments, items may be designated by a unique identifier, such as SKU, and used to manage products and services within or across enterprises or business units, such as tracking promotions, sales, fulfillment, supply chain, and other business, logistical, or technical operations. In some embodiments, SKUs may directly correlate to items available for purchase or otherwise tracked by a purchase, inventory, or asset system.

The blended models technology combines the strengths of decentralized and the hierarchical prediction models. The technology may utilize the internal classification structure of the items as well as reduce the number of coefficients to estimate. It may also significantly improve the out-of-sample prediction accuracy for items and/or departments. Moreover, computing systems often encounter “bad” SKUs in the dataset. These SKUs may have limited data (e.g., newly introduced items) or have very noisy observations. The clustering approach disclosed may help these “bad” SKUs by pooling together items and estimating cluster-level coefficients. It improves the demand prediction accuracy for those “bad” SKUs by leveraging the data from similar items. At the same time, it does not deteriorate the demand prediction for the SKUs with good data. The features and advantages described herein are not all-inclusive and many additional features and advantages will be apparent to one or ordinary skill in the art in view of the figures and description. Also, it should be noted that the language used in the specification has been selected for readability and instructional purposes and not to limit the scope of the inventive subject matter.

The determination of whether a SKU is “bad” or “good” may be based on computer learning algorithms to experimentally determine for a SKU, or a class of SKUs to which a particular SKU belongs, a metric describing the amount of data needed by a demand forecasting algorithm to make an accurate (e.g., within a defined threshold) prediction, referred to as a prediction accuracy metric. For example, an example metric described herein is the Weighted Mean Average Percentage Error (“MAPE”).

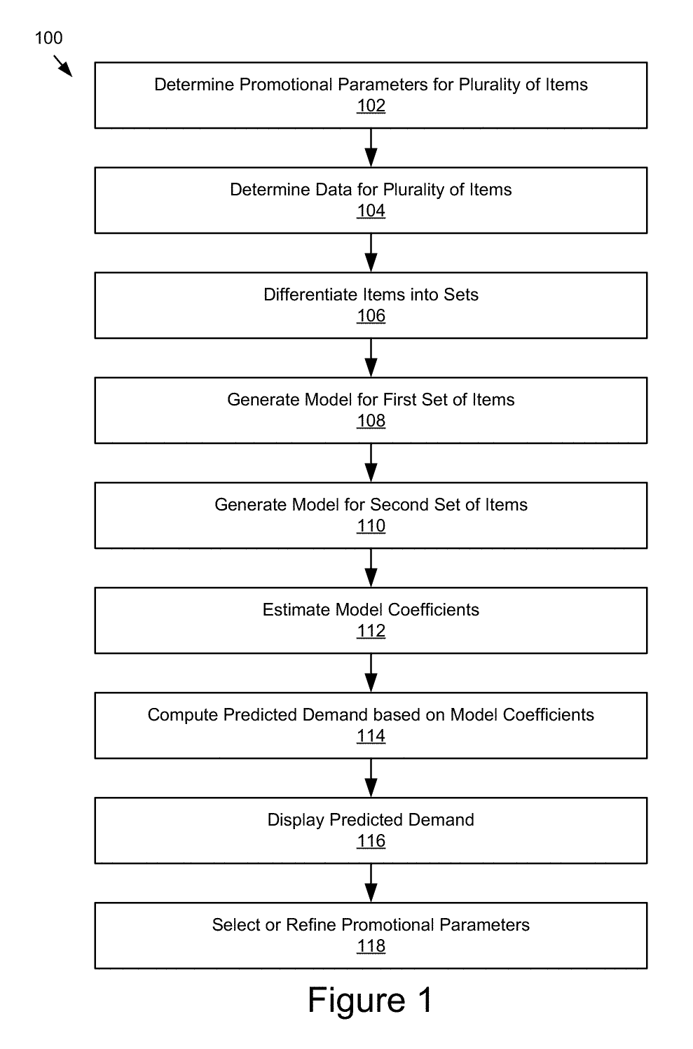

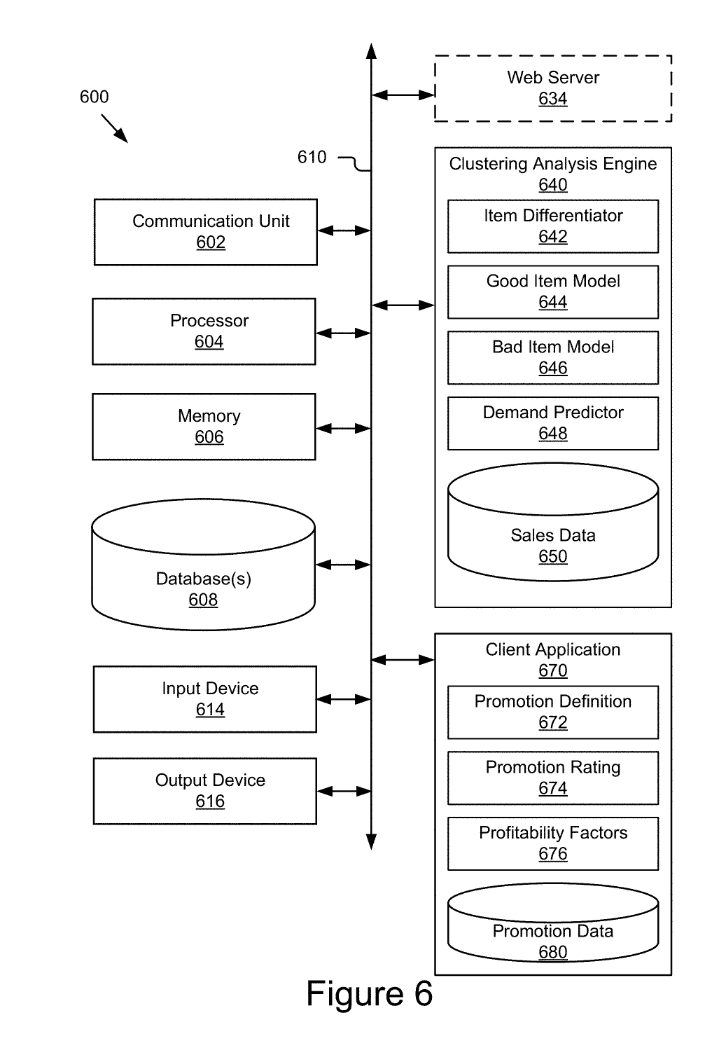

FIG. 1 illustrates an example method 100 for selecting and refining a prediction model for a promotion using blended clustering-based demand forecasting algorithms. Each of the operations of the method depicted in FIG. 1 is described in further detail below. At 102, a computer system, such as computing system 600 in FIG. 6, may determine promotional parameters for a plurality of items. In some embodiments, the proposed promotion may be captured in a file, method, command, or other data structure received by the computer system and defining a set of parameters describing the promotion, such as target SKUs, time period, promotion type, incentive value (e.g., discount, rebate, bonus product, etc.), etc. In some embodiments, the proposed promotion may be input into the computer system using a graphical user interface and one or more input devices (e.g., keyboard, mouse, touchscreen, etc.). For example, a client application, such as client application 670 in FIG. 6, may be provided for evaluating promotions through an interactive process with a user.

At 104, the computer system may determine data for the plurality of items from a database, third-party server, or other computing device. In some embodiments, the plurality of SKUs received may be defined by the proposed promotion in 102. For example, the proposed promotion may identify a department, product, range of SKUs, and/or other groupings selected using a product hierarchy, semantic analysis, or some other method of grouping SKUs relevant to the analysis of the promotion.

At 106, a computer modeling engine, such as clustering analysis engine 640 in FIG. 6, may differentiate items with good data from those with bad data. For example, a decentralized model may be used to calculate MAPE values for each SKU being analyzed and each SKU may be categorized as good or bad in comparison to a prediction accuracy threshold. This categorization may allow the SKUs to be separated into one or more sets of good SKUs and bad SKUs. Sets of good SKUs may be treated differently than sets of bad SKUs, while maintaining certain relationships between the different data sets and models that allows them to be used together for demand prediction. Note that “good” and “bad” have been used to designate between a first set of SKUs and a second set of SKUs based on prediction accuracy metrics, such that good SKUs are expected to have a higher correlation to accurate modeling due to the amount and quality of the data available and bad SKUs are expected to have a lower correlation.

At 108, the computer modeling engine may generate a model for the first set of items, such as the set of good SKUs, as further described below. The good SKUs may use a model that excludes cross-cluster effects with bad SKUs or removes other factors that may reduce accuracy based on the bad SKUs. The model generated for good SKUs may use a blended combination of hierarchical and decentralized models to increase the accuracy of the model over prior methods using only hierarchical models or only decentralized models. In some embodiments, good SKUs may be modeled using shared features' effects being estimated through a cluster-level fit model and unshared features' (including in-cluster) effects being estimated through a SKU-level fit model. In other embodiments, good SKUs may be modeled using a fit model at SKU-level without cluster effects for both shared and unshared features.

At 110, a model is generated for the second set of items, such as the set of bad SKUs, as further described below. The bad SKUs may use a model that uses the good SKUs to improve their accuracy and includes residual correction. In some embodiments, the bad SKUs may be modeled using cluster-level fit model of shared and unshared features, including cross-cluster effects, and implementing a SKU-level residual correction model using unshared features, including in-cluster effects. In other embodiments, the bad SKUs may be modeled with shared features' effects estimated through a decentralized model and unshared features' effects estimated through a hierarchical model.

At 112, the models for both sets of items (good SKUs and bad SKUs) may enable estimating model coefficients, such as using cluster-level regression. In some embodiments, SKU-level and cluster-level coefficients may be recovered for estimating a predicted demand.

At 114, a predicted demand value is generated from the differentiated models and their respective model coefficients for the different sets (good SKUs and bad SKUs). In some embodiments, predicted demand values may be generated for each SKU in the set of SKUs being analyzed. At 116, the predicted demand may be displayed to a user and, at 118, the proposed promotion may be selected or refined based on the predicted demand. In some embodiments, the predicted demand may be presented through a graphical user interface that enables a user to interactively and iteratively refine one or more parameters of the promotion in order to improve the predicted demand or otherwise adjust factors relevant to the proposed promotion meeting one or more business objectives.

An example system may use the following set of features in a model, although it should be noted that the model itself could be adapted to incorporate additional relevant features. Note that the index i may be used to denote a particular SKU and the index t to denote a period (e.g., a week). We also use j∈J to denote the set of clusters j(i) denotes the cluster that SKU i belongs to throughout this description. A SKU may belong to a single cluster with pₜⁱ˜0.843. A bad SKU may be in multiple clusters. Further notation may be summarized as follows:
1. i: the observed SKU, j∈J
2. t: the observed period of time t
3. dₜⁱ: the observed sales of SKU i during period t.
4. pₜⁱ: the average price of SKU i during period t. It includes both the base price and any kind of promotional discount.
5. Trendₜⁱ: the trend variable of SKU i during period t. It is defined as the cumulative number of periods starting from the earliest observation in the dataset.
6. PromoFlagₜⁱ: a [0,1] indicator showing whether we have a promotion for SKU i during period t. A promotion of SKU i occurs during period t when the SKU has a temporary price reduction (relative to the regular non-promotional price) during that period.
7. Fatigueₜⁱ: the number of periods since the last promotion for SKU i (set to 0 if there is no previous promotion). It is used to model the post-promotion dip effect which captures the stockpiling behavior of consumers.
8. Seasonalityₜⁱ: we use dummy variables to model the seasonality effect that the observed period t has to SKU i. Note that we can model the seasonality factors at the week level, month level, or even at the quarter level. For example, if we want to estimate the weekly seasonality effects, there would be 51 weekly dummies (we need to normalize for one of the weeks) in the model. The parameters Seasonalityₜⁱ would then simply represent the week index of SKU i during period t. It is worth noting that in order to avoid overfitting, we can robustly choose to estimate seasonality effects either at the department level or at the class/cluster level for the hierarchical/decentralized approach respectively (i.e., all the items in the same department are assumed to share the same seasonality factors). In the hierarchical approach each “department” is consisted of several “classes”; and each class includes a number of “SKU”. In the decentralized approach, the “classes” are replaced by attribute-based “clusters”.

For a sample department, all the SKUs may be clustered into different groups. Based on the SKU attributes (e.g., velocity: the sales last quarter per promo SKU, functionality, online classification index, color, brand, production cost) in the dataset, the system may choose any existing clustering method such as K-means, agglomerative clustering, or DBSCAN to create clusters. Alternatively, the system can even directly cluster the SKUs based solely on their attributes.

Example attributes may include, for instance, vendor, manufacturer, brand, images (e.g., image qualities) associated with a SKU (or item associated with the SKU), whether a SKU has reviews or ratings and the attributes of those reviews and ratings, whether a SKU is returnable, whether a SKU is on promotion or not, price, or other potential attributes, for example. Further, it should be noted that clustering may be performed based on defined attributes, hierarchies, or may be defined using K-means, or other clustering algorithms.

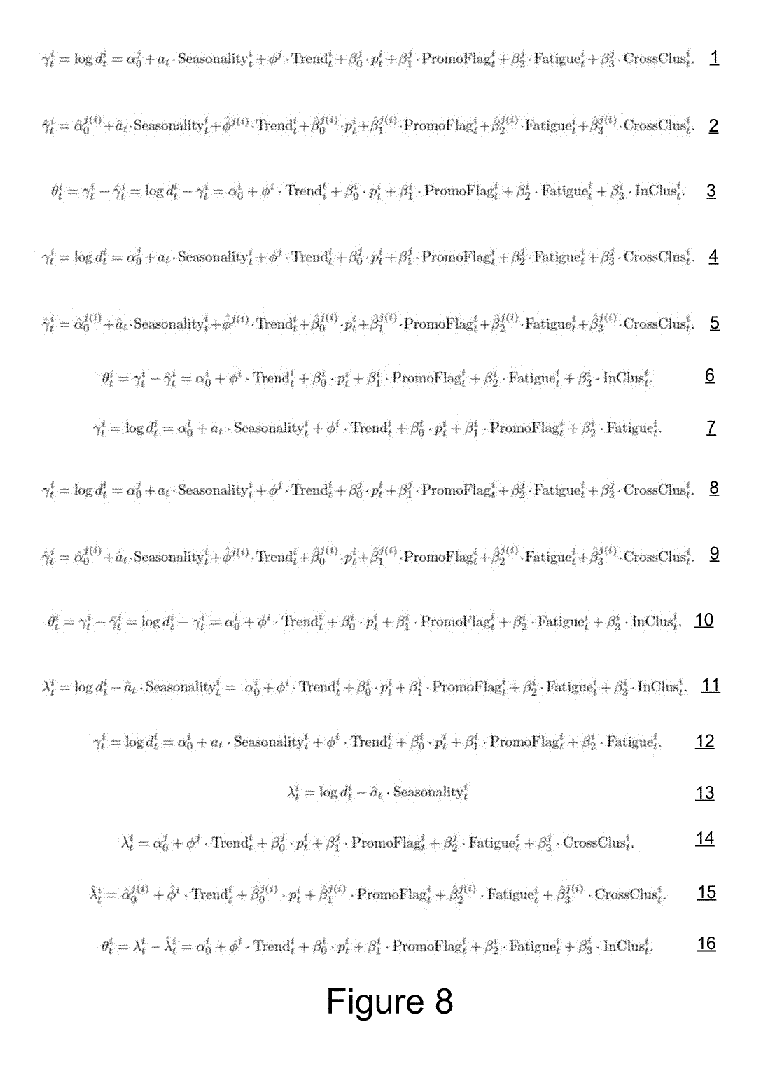

After clustering all the SKUs in the department, we can set up the cluster-level regression model which can be, for example, log-linear. In addition to the features defined above, some embodiments may use cluster-level indicators to capture the cross-cluster promotion effect for estimating the revenue rₜⁱ. For example, cluster-level indicator equation 1 in FIG. 8. In equation 1:

$$j ( i ) may be the cluster of SKU i$$

$${CrossClus}_{t}^{i} = 1 if ∃ SKU k ∈ \frac{J}{j ( i )} \text{:} {PromoFlag}_{t}^{k} = 1 ;$$

$$otherwise {CrossClus}_{i}^{i} = 0$$

Note that the CrossClus variable is time-dependent in that it is affected by the time-specific PromoFlag variable.

The parameters to estimate at the cluster-level is Pⱼ={α₀^{j}, α₀, ϕ^{j}, β₀^{j}, β₁^{j}, β₂^{j}, β₃^{j}}. Note that CrossClus may efficiently estimate the cannibalization and halo effects of promotions. Due to the curse of dimensionality, it may be unrealistic to estimate the cannibalization and halo effect for every pair of SKUs. In this example there are |J| coefficients to estimate. If β₃^{j}>0, it may be interpreted that promoting the SKUs from the other clusters can improve the sales of the SKUs in cluster j. This is an example of halo effect observed in retail. If β₃^{j}<0, this may correspond to a cannibalization effect across clusters. Note that equation 1 can also be adapted to include pairwise CrossClus features. In this case, the cannibalization or halo effect of promotion between any pair of clusters (i.e., how a promotion in any SKU of cluster i affects the demand of items in cluster j, and vice versa) may be measured.

The cluster-level predicted value for each observation by γₜⁱ may be modeled as shown in equation 2 of FIG. 8. The SKU-level i residual correction model ∀ cluster j, may be defined as shown in equation 3 of FIG. 8, where:

InClusₜⁱ=1, if ∃ some other SKU k∈j(i): PromoFlagₜⁱ=1; otherwise InClusₜⁱ=0

The parameters to estimate at the SKU-level is Pᵢ={α₀^{j}, α₀, ϕ^{j}, β₀^{j}, β₁^{j}, β₂^{j}, β₃^{j}}. In some embodiments, the SKUs within the same cluster may be similar to each other. Therefore, InClus may be used to characterize the substitution or complementarity effect across the SKUs that belong to the same cluster. In addition, note that there is no seasonality parameter in Pᵢ meaning that the only correction for the parameters in Pᵢ may be in the SKU-level model. This approach may be generalized when we have both individual features for each SKU (e.g., price, promotion flags, etc.) and shared features among several SKUs (e.g., seasonality, store effects, holiday effects, etc.) in our model. In some embodiments, a cluster-level model including both types of features may first be fit and then a SKU-level correction model may be fit for only the individual features.

An example set of regression equations for use of the SKU clustering model above without separate models for good SKUs and bad SKUs is provided in equations 4, 5, and 6 in FIG. 8. For example, equation 4 may be used to fit all SKUs to the model using the hierarchical approach at the cluster level and then equation 5 may be computed, in which j represents the cluster label and i is the SKU label. Then, using the values from equations 4 and 5, a residual correction model can be fit for all SKUs at SKU level without correcting for shared features using equation 6. However, residual correction without correcting for shared features may yield less accurate results than the example models provided below, which include compensation for shared features by separating the models for good SKUs and bad SKUs.

In some embodiments, interrelated clustering prediction models are used for good SKUs and bad SKUs. Two example model configurations are provided below. Example A and Example B try to separate good and bad SKUs so that good SKUs can have their own coefficients estimated independently. It is important to note that these two example methods will not deteriorate the demand prediction for the good SKUs. A distinction between the two examples is how the coefficients for the shared features are calculated. Example A uses the hierarchical type of model, whereas Example B uses the decentralized type of model. Note that the two example equations are fundamentally different. In the hierarchical equation 8, the parameters {ϕ^{j}, β₀^{j}, β₁^{j}, . . . } all have the superscript j, meaning that they are estimated at the cluster level. On the other hand, in decentralized equation 12 we have {ϕⁱ, β₀ⁱ, β₁ⁱ, . . . }, which means they are SKU level coefficients. As a result, the coefficients for the shared features from these two methods are different. This will later affect the second stage residual correction.

Additionally, in Example A only the good SKUs are de-seasonalized while in Example B all the SKUs are de-seasonalized. In some embodiments, for model selection purposes, each regression fitting step can be run by using any method (e.g., OLS, GLS, Lasso, Ridge etc.).

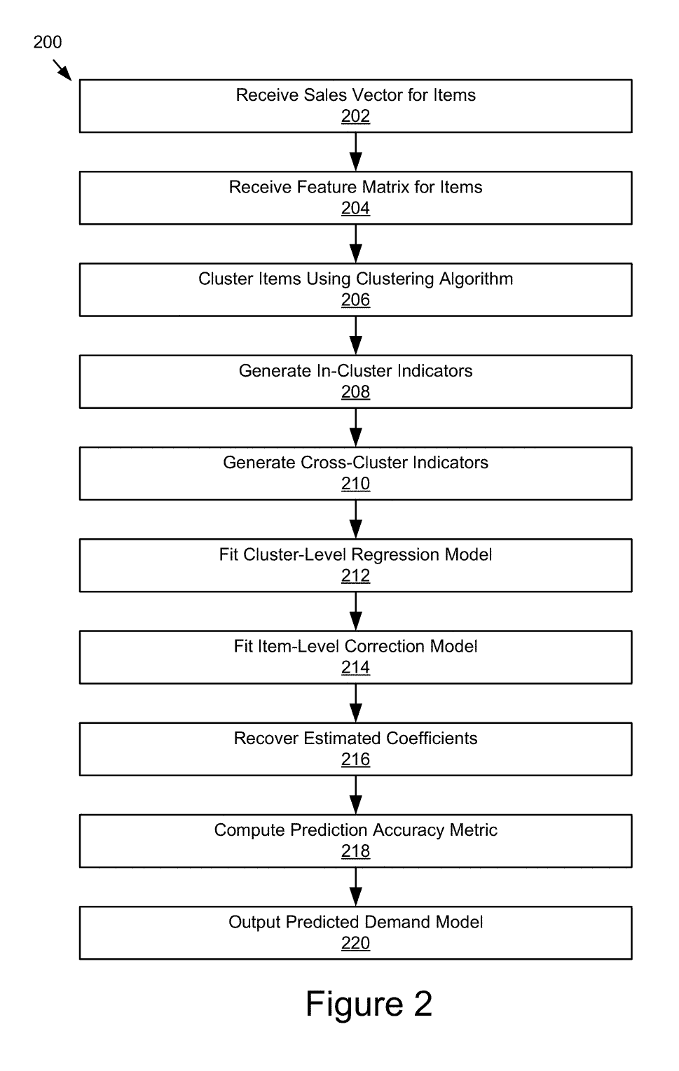

FIG. 2 illustrates an example method 200 for calculating predicted demand for a promotion using blended clustering-based demand models, such as Example A or Example B. In either case, at 202, a computer system may receive or calculate a sales vector for the items being used in the promotion analysis. For example, an observation vector (log dₜⁱ) for a selected batch of related SKUs, such as a department. At 204, the computer system may receive or calculate a feature matrix for the same items. For example, a data matrix may be assembled containing pₜⁱ, Trendₜⁱ, etc. for the batch of SKUs. In some embodiments, other SKU data and/or feature formats may be provided for the modeling equations being used.

At 206, the computer system may cluster the items using a selected clustering algorithm. For example, the initial clustering may be calculated using a decentralized model at the item-level. The computer system may be able to calculate predicted MAPE values for each item, set a threshold to define good and bad SKUs, and thereby sort the SKUs into good SKU sets and bad SKU sets be comparing the item's MAPE to the calculated prediction accuracy threshold. For example, equation 7 may be fit in Example A or equation 12 may be fit in Example B.

At 208, the computer system may generate in-cluster indicators for each item. In some embodiments, in-cluster indicators may include a parameter, variable, flag, argument, or similar designation of cluster relationships among and between SKUs, such as a cluster number associated with each SKU in the cluster. For example, each SKU in the cluster may be assigned an in-cluster indicator as a feature of the model being used for that SKU (good SKU or bad SKU).

At 210, the computer system may generate cross-cluster indicators for each item. In some embodiments, cross-cluster indicators may include a parameter, variable, flag, argument, or similar designation of relationships that span more than one cluster. For example, some SKUs may fit multiple clusters and/or features may be identified that show a statistically significant influence across multiple clusters and can be represented in a cross-cluster indicator value.

At 212, the computer system may fit a cluster-level regression model for each cluster identified at 206. In some embodiments, different approaches to fitting the cluster-level regression model may be used to distinguish the modeling of good SKUs from the modeling of bad SKUs. For example, each of Example A and Example B may handle cluster-level regression model fitting differently for their respective good SKUs and bad SKUs. Example A may fit the cluster-level regression model using equation 8 in FIG. 8. Example B may keep the fitted coefficients from 206 for good SKUs, estimate γₜⁱ, and remove one or more shared features from the model for all SKUs. For example, the seasonality term may be removed to de-seasonalize the model at the cluster-level, as shown in equation 13 in FIG. 8. The cluster model can then be fitted without the shared feature, such as shown in equation 14, and then used to compute equation 15, in which j represents the cluster label and i represents the SKU label.

At 214, the computer system may fit a item-level correction model for some or all SKUs in the batch. In some embodiments, different approaches to fitting the item-level correction model may be used to distinguish the modeling of good SKUs from the modeling of bad SKUs. For example, each of Example A and Example B may handle item-level regression model fitting differently for their respective good SKUs and bad SKUs. Example A may fit the SKU-level correction model within each cluster according to equation 10 for bad SKUs only, estimate θₜⁱ. For good SKUs, the data may have one or more shared features removed before fitting the regression mode. For example, the model may be de-seasonalized for the good SKUs by subtracting seasonality as shown in equation 11. Example B may fit item-level correction for bad SKUs only. For example, bad SKUs may fit the item-level correction model using equation 16.

At 216, the computer recovers estimated coefficients from the models. For example, all estimated coefficients may be recovered from the decentralized model in 206. In example B, only the estimated coefficients for the bad SKUs may be recovered because the original coefficients from the decentralized model were maintained for the good SKUs.

At 218, the computer calculates a prediction accuracy metric based on the recovered coefficients. For example, a weighted MAPE may be calculated at the SKU, cluster, and/or model levels.

At 220, the predicted demand model may be output by the computer system. For example, the predicted demand model and its estimated parameters, with or without the calculated prediction accuracy, may be provided to another computer system component, stored in a data repository for later use or additional processing, and/or displayed to a user through a graphical user interface for promotion decision-making. In some embodiments, the resulting predicted demand model may include different terms for good SKUs and bad SKUs, resulting in different demand models for good SKUs and bad SKUs. For example, under Example A the predicted demand model may include:

for i=good SKU: dₜⁱ=exp(λᵢ^{t}+αₜⁱ˜Seasonalityₜⁱ)

for i=bad SKU: dₜⁱ=exp(θₜⁱ+γₜⁱ)

As another example, under Example B the predicted demand model may include:

for i=good SKU: dₜⁱ=exp(γᵢ^{t}), where γᵢ^{t} is estimated from decentralized model

for i=bad SKU: dₜⁱ=exp(θₜⁱ+λₜⁱ+αₜⁱ·Seasonalityₜⁱ).

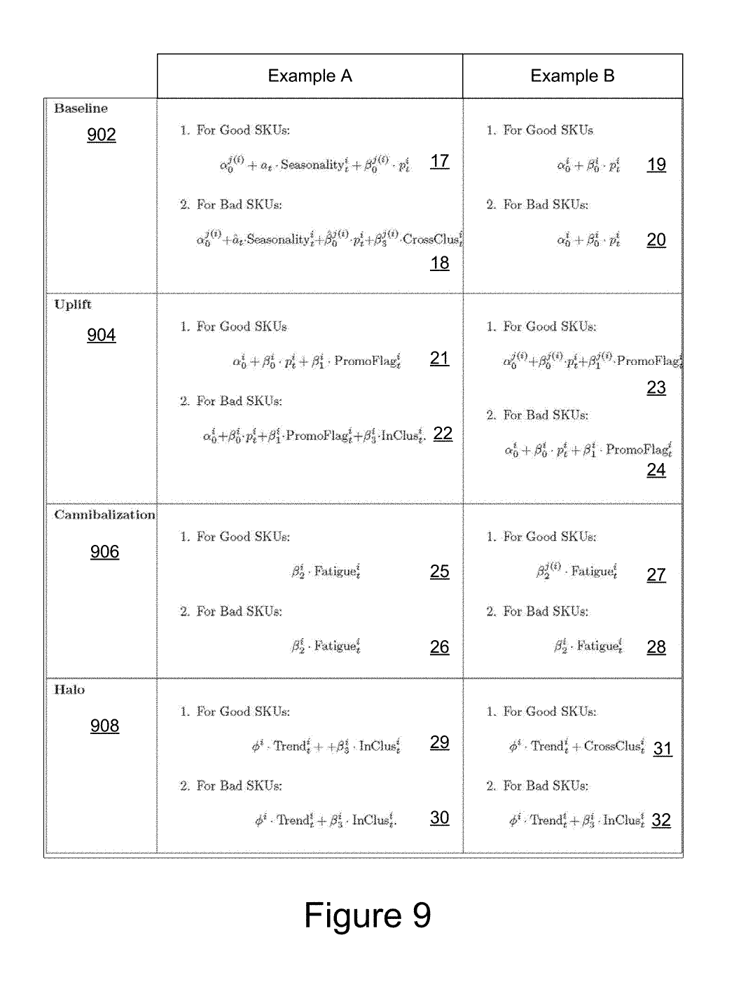

In some embodiments, the different terms of the predicted demand model may enable modeling and estimation of multiple predicted demand values, where the predicted demand values are determined differently for good SKUs and bad SKUs. FIG. 9 includes a table showing example calculations for predicted demand values based on Example A and Example B for good SKUs and bad SKUs. For example, baseline value 902 may be calculated using selected factors from the good SKU predicted demand model and the bad SKU predicted demand model. In Example A, baseline value 902 for good SKUs may be calculated with equation 17 and bad SKUs may be calculated with equation 18. In Example B, baseline value 902 for good SKUs may be calculated using equation 19 and bad SKUs may be calculated using equation 20. Uplift value 904 may be calculated using equations 21, 22, 23, and 24. Cannibalization value 906 may be calculated using equations 25, 26, 27, and 28. Halo effect value 908 may be calculated using equations 29, 30, 31, and 32.

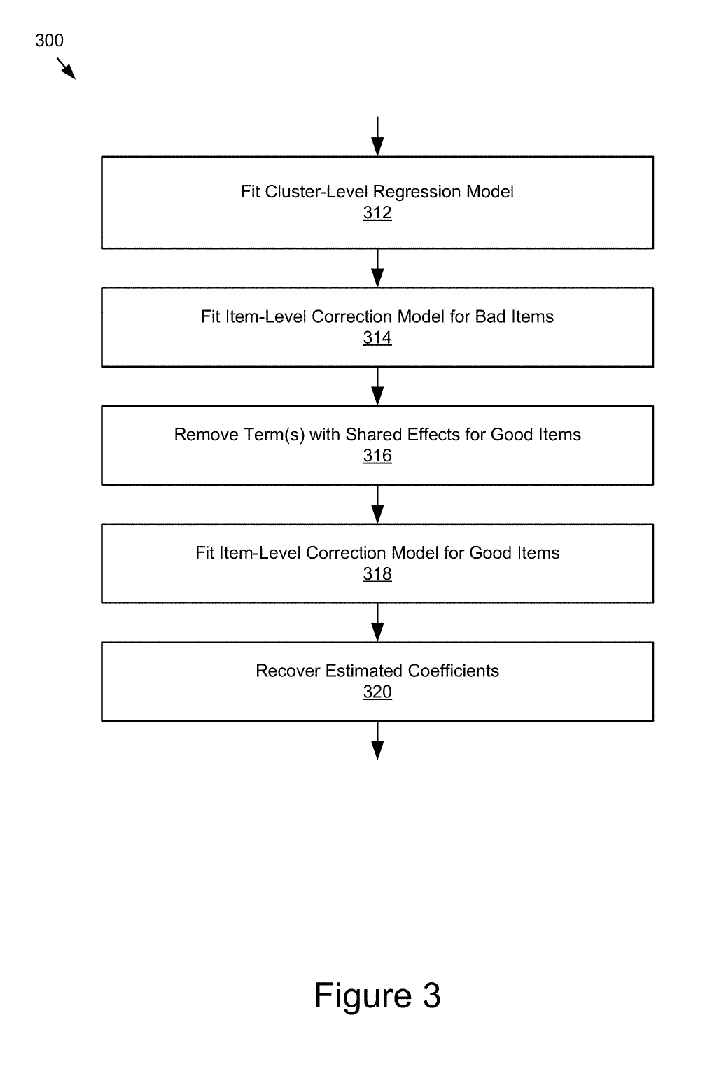

FIG. 3 shows a method 300 for fitting regression equations in accordance with Example A and similar embodiments. In some embodiments, method 300 may be implemented within methods similar to methods 100 and 200 in FIGS. 1 and 2 respectively. In some embodiments, method 300 may use a decentralized regression model both to identify good SKUs and bad SKUs and other models are used for fitting both bad SKUs and good SKUs. For example, a shared hierarchical model may be used to estimate the fit of the good SKUs, where shared features' effects are estimated through a cluster-level fit model and unshared features' effects (including in-cluster features) are estimated through a SKU-level fit model. In some embodiments, method 300 may use a hierarchical model for fitting bad SKUs, where a cluster-level fit model of shared and unshared features including cross-cluster effects is combined with SKU-level residual correction using unshared features including in-cluster effects. For example, a decentralized model may be used to estimate shared features' effects and a hierarchical model may be used to estimate unshared features' effects.

At 312, a computer system fits a cluster level regression model for all items. For example, a decentralized model may be used for all SKUs. Example A may fit the cluster-level regression model using equation 8 in FIG. 8 and then compute equation 9 in FIG. 8, where j represents the cluster label and i the SKU label.

At 314, the computer system fits an item-level correction model for bad items. For example, a residual correction model may be fit at the item-level for only the bad SKUs without correcting for the shared features, such that data from the good SKUs is used in the residual correction of the bad SKUs. Example A may fit the residual correction model for bad SKUs using equation 10 in FIG. 8.

At 316, the computer system may remove one or more terms with shared effects before fitting item-level correction for good items (at 318). For example, one or more features identified with shared effects or cross-cluster effects may have their terms subtracted from the item-level correction model used for the bad SKUs. Example A may have the seasonality term removed.

At 318, the computer system may fit a item-level correction model for good items. For example, a residual correction model may be fit at the item-level for only the good SKUs without the shared features or cross-cluster effects. Example A may fit the residual correction model for good SKUs using equation 11 in FIG. 8, where λₜⁱ is the same as equation 9. At 320, the computer system may recover the estimated coefficients.

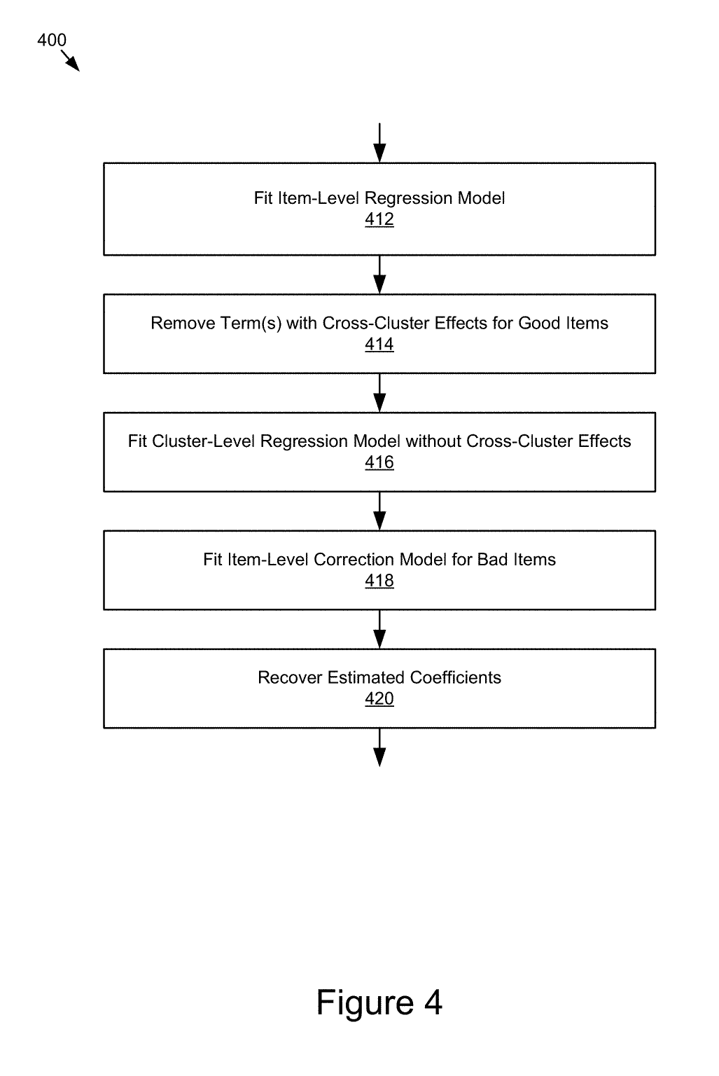

FIG. 4 shows a method 400 for fitting regression equations in accordance with Example B and similar embodiments. In some embodiments, method 400 may be implemented within methods similar to methods 100 and 200 in FIGS. 1 and 2 respectively. In some embodiments, method 400 may use a decentralized regression model both to identify good SKUs and bad SKUs and to fit the item-level model for good SKUs. For example, a decentralized model may fit the model at the item-level without cluster effects for both shared and unshared features. In some embodiments, method 400 may use a mixed model for fitting bad SKUs at the item-level. For example, a decentralized model may be used to estimate shared features' effects and a hierarchical model may be used to estimate unshared features' effects.

At 412, a computer system may fit an item-level regression model for at least the good items. For example, a decentralized model may be used to fit all SKUs at the item-level. In some embodiments, the item-level regression model may be fit for all SKUs and used to calculate initial MAPE values for differentiating good SKUs from bad SKUs. Example B may fit the item-level regression model using equation 12 in FIG. 8. The coefficients estimated using equation 12 may be kept for the good SKUs, because there are no cross-cluster effects.

At 414, the computer system may remove one or more terms with cross-cluster effects for good items. For example, one or more terms with cross-cluster effects can be calculated for all SKUs. Example B may compute the removal of the seasonality term using equation 13 in FIG. 8.

At 416, the computer system may fit a cluster-level regression model without cross-cluster effects for all items. For example, a cluster-level model with shared terms removed may be fit for all SKUs. Example B may fit a de-seasonalized model at the cluster-level using equation 14 in FIG. 8, followed by computing equation 15 in FIG. 8, where j represents the cluster label and i represents the SKU label.

At 418, the computer system may fit an item-level correction model for bad items. For example, a residual correction model may be fit for decentralized demand at item-level. Example B may fit the residual correction mode for bad SKUs using equation 16 in FIG. 8. At 420, the computer system may recover the estimated coefficients for the bad items.

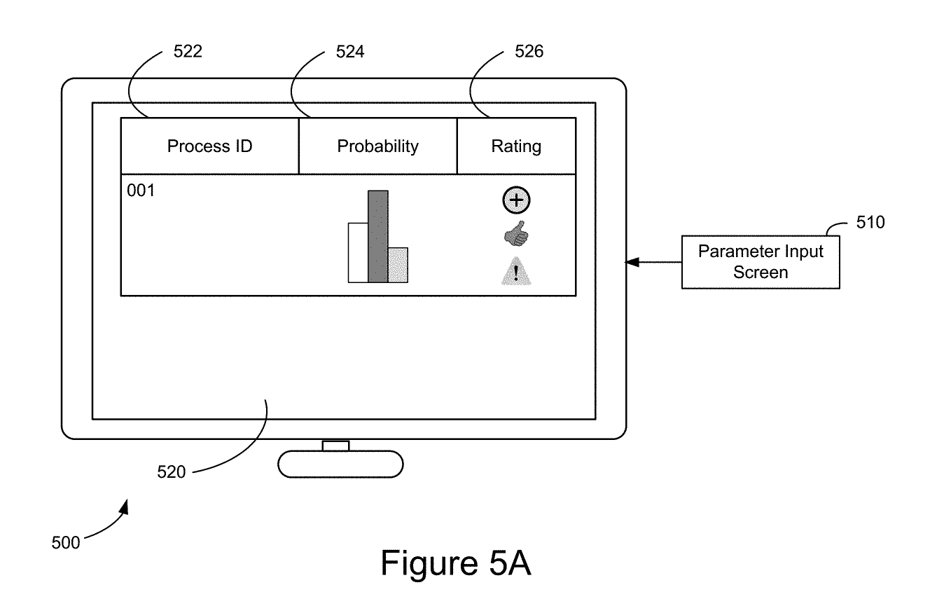

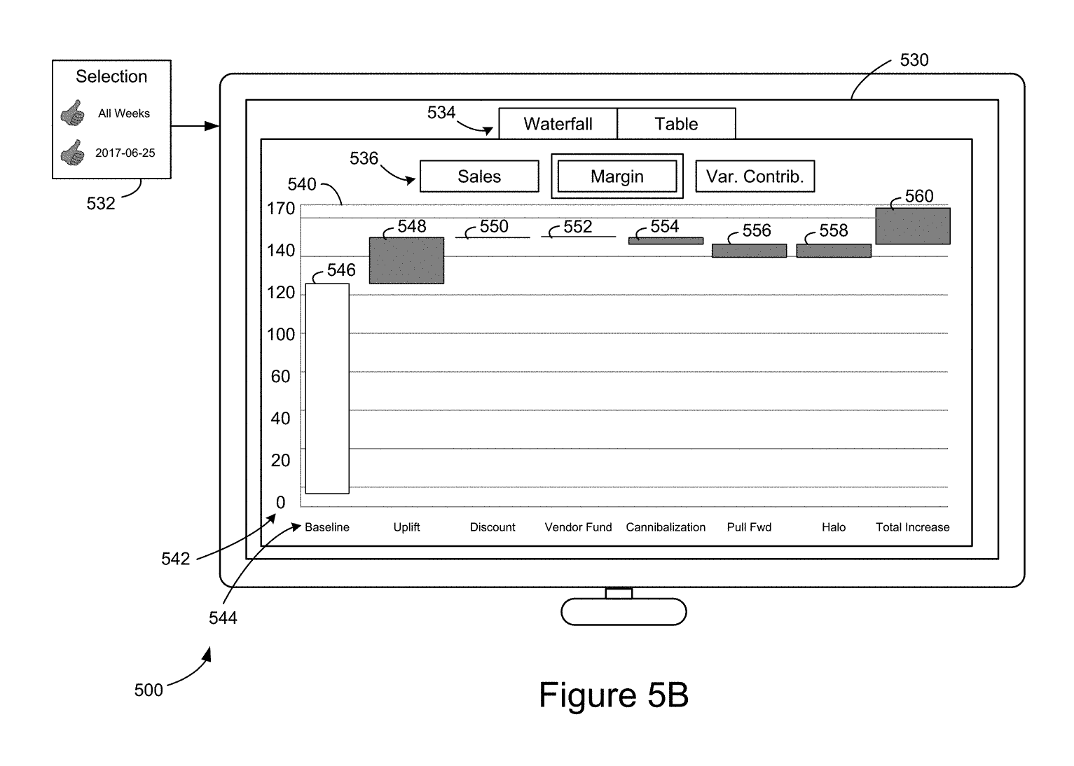

FIGS. 5A and 5B illustrate a graphical user interface 500 that may be used to initiate and manage a promotion demand prediction, such as using the method 100 in FIG. 1. In some embodiments, graphical user interface 500 may be presented on a computer system, such computing system 600 in FIG. 6, as a user-friendly, explicit visualization of the predicted demand values generated by of the blended models described above. For example, graphical user interface 500 may configure the output display of a computer system, such as a personal computer, smartphone, or tablet computer, running a client application that configures the elements of graphical user interface 500 as screens, windows, tiles, or other graphical elements for interaction with a user.

In some embodiments, graphical user interface 500 includes a parameter input screen 510 configured to enable the user to define promotion parameters the user would like to model. For example, parameter input screen 510 may include a plurality of parameters for defining a data set (such as sales data related to the SKUs of a particular department), target product (by SKU, description, or some other unique identifier), and terms of the proposed promotion. In some embodiments, some or all of these parameters may be selected automatically by the computer system in response to a trigger for modeling the promotion and the user may review and modify the parameters as appropriate. In some embodiments, a unique promotion identifier (or promo ID) may be assigned to set of promotion parameters being modeled and/or the session of iterative modeling of related proposed promotions. Once the proposed promotion is defined by the user, the proposed promotion parameters may be submitted to the computer system (or another computer system) configured to analyze the promotion using the computer modeling technology described above. For example, the proposed promotion may be defined in a file, method, command, or other data structure defining a set of parameters describing the promotion that is submitted to a clustering analysis engine implementing the methods above. The computer system may process the proposed promotion using blended models of demand prediction and return one or more demand prediction values and related indicators.

In some embodiments, one or more promotion analyses may be displayed in a summary interface 520. In the example shown, each promotion may be identified by its unique promotion identifier 522. Promotion identifier 522 may be associated with or store promotion parameters and other relevant information for managing promotions, including but not limited to the promotion number, the manager of that promotion; and some comments on the nature of the promotion-such as coupons; holiday promotion; and targeted/segmented promotion, etc.

In some embodiments, summary interface 520 may include one or more indicators for rating each promotion in the summary. For example, a profitability metric 524 may provide a graphical or numeric rating and/or a profitability value, such as incremental net profit, return on investment, incremental sales, etc. As another example, a promotion rating 526 may rate the proposed promotion against a defined success metric, such as a profitability target. For example, promotion rating 526 may include a “thumbs up” for a highly profitable promotion (that exceeds a certain profitability metric), “plus” sign for good margin (within a defined margin threshold), or a “triangle with exclamation mark” for promotions that just meet the goals. In some embodiments, proposed promotions that do not meet any defined goal may be displayed with a graphical warning indicator and/or may direct the user back to promotion input screen 510 to refine the proposed promotion.

In some embodiments, a more detailed promotion analysis display 530 may be provided for review by the user. For example, the user may be able to select a promotion identifier and be presented with a graphical representation of predicted demand from the model represented in a business-significant series of predicted demand values. In some embodiments, promotion analysis display 530 may include one or more interactive features for enabling the user to drill down into the analysis, see the data from different perspectives, and/or provide other utilities for visualizing, manipulating, or exporting the predicted demand values. In the example shown, time selector 532 may indicate a plurality of time segments, such as by week or combined for the entire period of the promotion, that may be selected for viewing the performance of the promotion in the various segments. Presentation selector 534 may provide a selection of visualization settings for the data, such as waterfall view or table view. Metric selector 536 may provide a selection of business metrics against which the modeled promotion can be displayed, such as incremental adjusted margin, incremental sales, and incremental variable contribution of each particular component of the promotion as represented in predicted demand values.

In the example shown, a waterfall chart 540 is displaying the predicted demand values in terms of incremental adjusted margin and the contribution of various predicted demand values that can be derived from the models. The contribution to adjusted margin is shown on y-axis 542 and the different predicted demand values are arranged along the x-axis 544. For example, predicted demand values are shown for baseline 546, uplift 548, discount 550, vendor fund 552, cannibalization 554, pull forward 556, halo effect 558, and total incremental value 560. Example equations for calculating these values from the blended models are shown in FIG. 9.

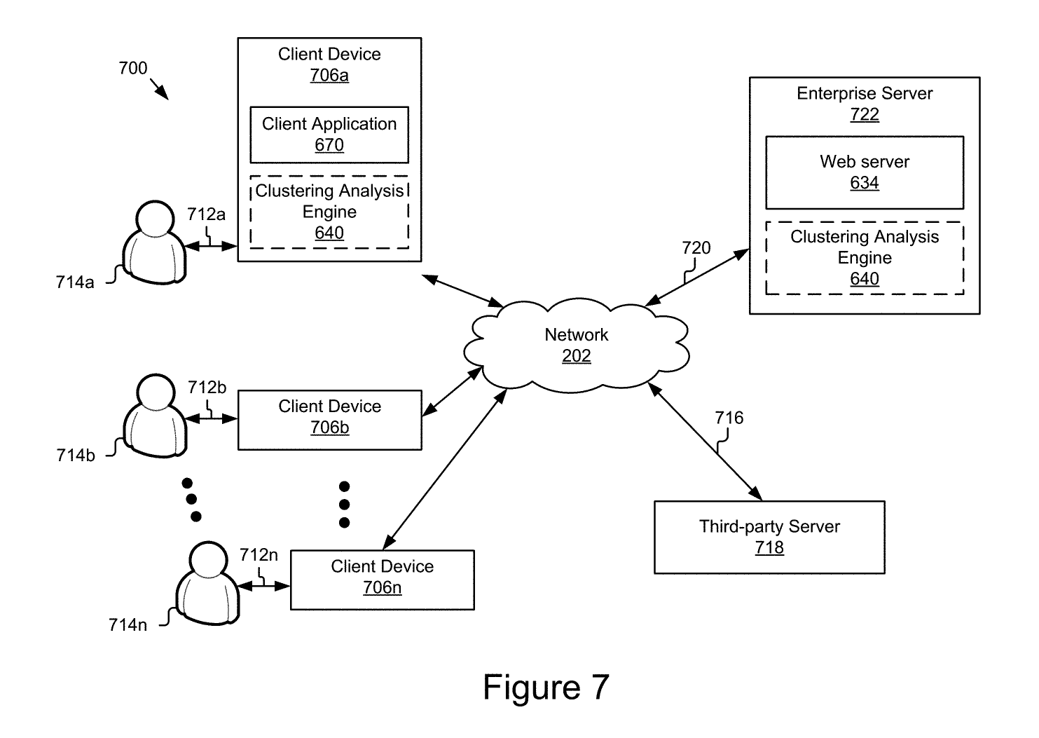

An example computing system 600 using the technology is depicted in FIG. 6. This computing system 600 may represent the computer architecture of a client device 706, a third-party server 718, and/or an enterprise server 722, as depicted in FIG. 7, and may include different components depending on the implementation being represented.

As depicted in FIG. 6, computing system 600 may include one or more of a web server 634, a clustering analysis engine 640, and a client application 670, depending on the configuration. For instance, a client device 706 may include one or more of client application 670, clustering analysis engine 640, and/or components thereof, although it should be understood that other configurations are also possible, such as configurations where client application 670 and clustering analysis engine 640 are combined into a single entity or further distributed into additional components. Enterprise server 722 may include web server 634, clustering analysis engine 640, and/or components thereof, the database(s) 608, etc., although other configurations are also possible and contemplated.

In some embodiments, such as client devices 706, computing system 600 may also store and/or operate other software, such as client application 670, clustering analysis engine 640, operating system, other applications, etc., that are configured to interact with enterprise server 722 via network 702.

Web server 634 includes computer logic executable by processor 604 to receive, process, and respond to content requests. Web server 634 may include an HTTP server, a REST (representational state transfer) service, or other suitable server type. Web server 634 may receive content requests (e.g., page requests, order requests, other requests (e.g., HTTP), etc.) from client devices 706, cooperate with clustering analysis engine 640 to determine the content, retrieve and incorporate data from database(s) 608, format the content, and provide the content to the client devices. In some instances, web server 634 may format the content using a web language and provide the content to a corresponding client application 670 for processing and/or rendering to the user for display, although other variations are also possible.

Web server 634 may be coupled to the database(s) 608 to store retrieve, and/or manipulate data stored therein and may be coupled to clustering analysis engine 640 to facilitate its operations. For example, web server 634 may allow a user on a client device 706 to communicate with clustering analysis engine 640.

Clustering analysis engine 640 includes computer logic executable by the processor 604 to parse data and perform the clustering and analysis operations described herein, for example. Cluster analysis engine 640 may include computer modeling software and/or hardware for selecting and processing one or more blended models for regression-based cluster analysis. Clustering analysis engine 640 may store and/or provide access to a sales data source 650. For example, sales data source 650 may include demand information, item information (e.g., SKUs, images, descriptions, categories, specifications, reviews, ratings, retailers, quantities, attributes, criteria, parameters, etc.), sales history, promotion history, etc. In some embodiments, some or all of the data in sales data source 650 may be retrieved from the database(s) 608.

The clustering analysis engine 640 may communicate with the web server 634 to facilitate its operations and may be coupled to the database(s) 608 to store retrieve, and/or manipulate data stored therein. For example, the clustering analysis engine 640 may retrieve item data from a third-party server 718 and store it in the database(s) 608.

The clustering analysis engine 640 may include software including logic executable by the processor 604 to perform its respective acts, although in further embodiments the clustering analysis engine 640 may be implemented in hardware (one or more application specific integrated circuits (ASICs) coupled to the bus 610 for cooperation and communication with the other components of the system 600; sets of instructions stored in one or more discrete memory devices (e.g., a PROM, FPROM, ROM) that are coupled to the bus 610 for cooperation and communication with the other components of the system 600; a combination thereof; etc.).

In some embodiments, clustering analysis engine 640 may include one or more modules corresponding to a logical process for calculating demand predictions from a batch of SKU-related sales data in sales data 650. For example, clustering analysis engine 640 may include a item differentiator 642, a good item model 644, a bad item model 646, and a demand predictor 648. In some embodiments, these modules may be redundantly used or repeated in separate instances for each batch of SKUs and/or each proposed promotion evaluated by clustering analysis engine 640.

Item differentiator 642 may include logic for using processor 604 and memory 606 to retrieve a batch of item-related sales data and process it to differentiate good items from bad items. For example, item differentiator 642 may fit a item-level regression model, such as a decentralized model, for all items. Item differentiator 642 may compute predicted MAPE values for each item based on the fit (and coefficients) of the item-level regression model. In some embodiments, item differentiator 642 may include a predefined differentiation threshold or may determine the differentiation threshold based on statistical analysis of the distribution of MAPE values. Item differentiator 642 may separate good items and bad items into their respective sets based on comparison to the threshold. Good items may have a MAPE value above the threshold and bad items may have a MAPE value below the threshold. Note that “above” and “below” may not necessarily correlate to numeric values being higher or lower, but merely indicates that items on the good side of the threshold demonstrate better prediction accuracy than items on the bad side of the threshold. In some embodiments, item differentiator 642 adds a data quality indicator to the feature set or other associated data for each item that indicates whether it is in the set of good items or the set of bad items.

Good item model 644 and bad item model 646 and the process and logic for generating these differentiated models has been described above with regard to the methods of FIGS. 1-4. As described above, good item model 644 and bad item model 646 may each include a combination of regression model fits to yield a predicted model with coefficients and values specific to each selected item and whether it is a good item or a bad item.

Demand predictor 648 evaluates the good item model(s) 644 and/or bad item model(s) 646 with data values relevant to a proposed promotion to generate one or more predicted demand values for the particular item. Example predicted demand equations, differentiated by good item models and bad item models, are provided in FIG. 9. Demand predictor 648 may calculate and store predicted demand values and/or transmit or otherwise provide them for use by another system, display, or further processing. In some embodiments, demand predictor 648 provides the good item model or bad item model for the particular item, one or more predicted demand values, and one or more prediction quality metrics to client application 670 for use in promotion evaluation and management.

Client application 670 includes computer logic executable by processor 604 on a client device 706 to provide for user interaction, receive user input, present information to the user via a display, and send data to and receive data from the other entities of system 700 via the network 702. In some implementations, client application 670 may generate and present user interfaces based at least in part on information received from clustering analysis engine 640 and/or web server 634 via the network 702. In some implementations, client application 670 includes a web browser and/or code operable therein, a customized client-side application (e.g., a dedicated mobile app), a combination of both, etc. Example interfaces that can be displayed by client application 670 are shown in FIGS. 5A and 5B.

In some embodiments, client application 670 provides a user application for modeling proposed promotions based on heterogeneous sales data and clustering analysis engine 640. For example, a user may define a proposed promotion, including product(s), timing, location, and promotional details (e.g. discount, rebate, bundle, etc.). Clustering analysis engine 640 may receive selected information regarding the proposed promotion, determine or receive the batch of items relevant to modeling and the particular items in the promotion, and provide one or more predicted demand values to client application 670 based on modeling the promotion. Client application 670 may then format and display the predicted demand values for interaction by the user, which may include selection or refinement of the proposed promotion. In some embodiments, client application 670 may provide additional visualization tools to enhance the business context and/or decision-making around the proposed promotion and predicted demand.

In some embodiments, client application 670 may include a plurality of modules related to defining and presenting proposed promotions. For example, client application 670 may include a promotion definition module 672, a promotion rating module 674, and profitability factors module 676. Each of these modules may store and/or provide access to promotion data store 680. Each of these modules may interact with clustering analysis engine 640 and/or blended models for good items and bad items, predicted demand values, prediction quality metrics, and other output from clustering analysis engine 640.

Promotion definition module 672 may receive one or more parameters for defining a proposed promotion. For example, promotion definition module 672 may receive target SKUs, time period, promotion type, incentive value (e.g., discount, rebate, bonus product, etc.), etc. In some embodiments, a graphical user interface for entering one or more parameters for a proposed promotion may be provided, such as promotion input screen 510 in FIG. 5A.

Promotion rating module 674 may receive predicted demand values and one or more promotion rating metrics for evaluating proposed promotions. For example, predicted demand values may be used to calculate promotion performance over a certain period and compare the proposed promotion against historical metrics and/or specific business targets in terms of profitability, return on investment, or other key metrics. In some embodiments, a graphical user interface for reviewing promotion ratings for a proposed promotion may be provided, such as promotion summary interface 520 in FIG. 5A.

Profitability factors module 676 may use the blended model (good item or bad item) for a particular item or group of items in a proposed promotion to calculate and visualize one or more profitability factors related to the predicted demand values. For example, defined factors within the model being used may correlate to specific profitability factors, such as baseline, uplift, discount, vendor fund, cannibalization, pull forward, halo effect, and total incremental value, among others. In some embodiments, a graphical user interface for visualizing and navigating one or more profitability factors for a proposed promotion may be provided, such as promotion analysis display 530 in FIG. 5B.

As depicted, computing system 600 may include a processor 604, a memory 606, a communication unit 602, an output device 616, an input device 614, and database(s) 608, which may be communicatively coupled by a communication bus 610. Computing system 600 depicted in FIG. 6 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, computing system 600 may include various operating systems, sensors, additional processors, and other physical configurations. Although, for purposes of clarity, FIG. 6 only shows a single processor 604, memory 606, communication unit 602, etc., it should be understood that computing system 600 may include a plurality of one or more of these components.

Processor 604 may execute software instructions by performing various input, logical, and/or mathematical operations. Processor 604 may have various computing architectures to method data signals including, for example, a complex instruction set computer (CISC) architecture, a reduced instruction set computer (RISC) architecture, and/or an architecture implementing a combination of instruction sets. Processor 604 may be physical and/or virtual, and may include a single core or plurality of processing units and/or cores. In some implementations, processor 604 may be capable of generating and providing electronic display signals to a display device, supporting the display of images, capturing and transmitting images, performing complex tasks including various types of feature extraction and sampling, etc. In some implementations, processor 604 may be coupled to memory 606 via bus 610 to access data and instructions therefrom and store data therein. Bus 610 may couple processor 604 to the other components of computing system 600 including, for example, memory 606, communication unit 602, input device 614, output device 616, and database(s) 608.

Memory 606 may store and provide access to data to the other components of computing system 600. Memory 606 may be included in a single computing device or a plurality of computing devices. In some implementations, memory 606 may store instructions and/or data that may be executed by processor 604. For example, memory 606 may store one or more of a web server 634, a clustering analysis engine 640, a client application 670, and their respective components, depending on the configuration. Memory 606 is also capable of storing other instructions and data, including, for example, an operating system, hardware drivers, other software applications, databases, etc. Memory 606 may be coupled to bus 610 for communication with processor 604 and the other components of computing system 600.

Memory 606 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with processor 604. In some implementations, memory 606 may include one or more of volatile memory and non-volatile memory (e.g., RAM, ROM, hard disk, optical disk, etc.). It should be understood that memory 606 may be a single device or may include multiple types of devices and configurations.

Bus 610 can include a communication bus for transferring data between components of a computing device or between computing devices, a network bus system including network 702 or portions thereof, a processor mesh, a combination thereof, etc. In some implementations, web server 634, clustering analysis engine 640, client application 670, and various other components operating on computing device 600 (operating systems, device drivers, etc.) may cooperate and communicate via a communication mechanism included in or implemented in association with bus 610. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

Communication unit 602 may include one or more interface devices (I/F) for wired and wireless connectivity among the components of system 700. For instance, communication unit 602 may include various types known connectivity and interface options. Communication unit 602 may be coupled to the other components of computing system 600 via bus 610. Communication unit 602 may be electronically communicatively coupled to network 702 (e.g., wiredly, wirelessly, etc.). In some implementations, communication unit 602 can link processor 604 to network 702, which may in turn be coupled to other processing systems. Communication unit 602 can provide other connections to network 702 and to other entities of system 700 using various standard communication protocols.

Input device 614 may include any device for inputting information into computing system 600. In some implementations, input device 614 may include one or more peripheral devices. For example, input device 614 may include a keyboard, a pointing device, microphone, an image/video capture device (e.g., camera), a touch-screen display integrated with output device 616, etc.

Output device 616 may be any device capable of outputting information from computing system 600. Output device 616 may include one or more of a display (LCD, OLED, etc.), a printer, a 3D printer, a haptic device, audio reproduction device, touch-screen display, etc. In some implementations, the output device is a display which may display electronic images and data output by computing system 600 for presentation to a user 714. In some implementations, computing system 600 may include a graphics adapter (not shown) for rendering and outputting the images and data for presentation on output device 616. The graphics adapter (not shown) may be a separate processing device including a separate processor and memory (not shown) or may be integrated with the processor 604 and memory 606.

Database(s) are information source(s) for storing and providing access to data. The data stored by database(s) 608 may organized and queried using various criteria including any type of data stored by them, such as a customer identifier, business identifier, order ID, IP address, rewards account number, item identifier, item attributes, item name, etc. Database(s) 608 may include file systems, data tables, documents, databases, or other organized collections of data. Examples of the types of sales data stored by database(s) 608 may include invoice data, item data, business account data, purchase data, user profile data, etc.

The components 634, 640, 670, and/or components thereof (e.g., 642-648, 672-676, etc.), may be communicatively coupled by bus 610 and/or processor 604 to one another and/or the other components of the computing system 600. In some implementations, the components 634, 640, and/or 670 may include computer logic (e.g., software logic, hardware logic, etc.) executable by the processor 604 to provide their acts and/or functionality. In any of the foregoing implementations, these components 634, 640, and/or 670 may be adapted for cooperation and communication with processor 604 and the other components of the computing system 600.

Database(s) 608 may be included in computing system 600 or in another computing system and/or storage system distinct from but coupled to or accessible by computing system 600. Database(s) 608 can include one or more non-transitory computer-readable mediums for storing the data. In some implementations, database(s) 608 may be incorporated with memory 606 or may be distinct therefrom. In some implementations, database(s) 608 may store data associated with a database management system (DBMS) operable on computing system 600. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

FIG. 7 is a block diagram of an example system 700 for determining and implementing clustering-based demand forecasting algorithms. The illustrated system 700 may include a client device 706a . . . 706n (also referred to herein individually and/or collectively as 706), a third-party server 718, and an enterprise server 722, which are electronically communicatively coupled via a network 702 for interaction with one another, although other system configurations are possible including other devices, systems, and networks. For example, system 700 could include any number of client devices 706, third-party servers 718, enterprise servers 722, and other systems and devices. Client devices 706a . . . 706n, and their components, may be coupled to the network 702. Enterprise server 722 and its components may be coupled to the network 702. Third-party server 718 and its components may be coupled to the network 702. Users 714a . . . 714n may access one or more of the devices of the system 700. For example, as depicted, a user 714a may access and/or interact with client device 706a as illustrated, a user 714b may access and/or interact with client device 706b as illustrated, and a user 714n may access and/or interact with client device 706n as illustrated.

Network 702 may include any number of networks and/or network types. For example, network 702 may include one or more local area networks (LANs), wide area networks (WANs) (e.g., the Internet), virtual private networks (VPNs), wireless wide area network (WWANs), WiMAX® networks, personal area networks (PANs) (e.g., Bluetooth® communication networks), various combinations thereof, etc. These private and/or public networks may have any number of configurations and/or topologies, and data may be transmitted via the networks using a variety of different communication protocols including, for example, various Internet layer, transport layer, or application layer protocols. For example, data may be transmitted via the networks using TCP/IP, UDP, TCP, HTTP, HTTPS, DASH, RTSP, RTP, RTCP, VOW, FTP, WS, WAP, SMS, MMS, XMS, IMAP, SMTP, POP, WebDAV, or other known protocols.

A plurality of client devices 706a . . . 706n are depicted in FIG. 7 to indicate that enterprise server 722 and its components may provide services to a multiplicity of users 714a . . . 714n on a multiplicity of client devices 706a . . . 706n. In some implementations, a single user may use more than one client device 706, which enterprise server 722 may receive and manage data associated with the user and use to perform its acts and/or functions as discussed elsewhere herein.

Client device 706 includes one or more computing devices having data processing and communication capabilities. Client device 706 may couple to and communicate with other client devices 706 and the other entities of system 700 via network 702 using a wireless and/or wired connection. Examples of client devices 706 may include mobile phones, tablets, laptops, desktops, netbooks, server appliances, servers, virtual machines, TVs, etc. System 700 may include any number of client devices 706, including client devices of the same or different type.

Enterprise server 722 and third-party server 718 have data processing, storing, and communication capabilities, as discussed elsewhere herein. For example, servers 722 and/or 718 may include one or more hardware servers, server arrays, storage devices and/or systems, etc. In some implementations, servers 722 and/or 718 may include one or more virtual servers, which operate in a host server environment. As depicted, enterprise server 722 may include clustering analysis engine 640 and web server 634, as discussed elsewhere herein.

Third-party server 718 can host services such as a third-party application (not shown), which may be individual and/or incorporated into the services provided by enterprise server 722. In some implementations, the third-party application provides additional acts and/or information such as browsing history, tracking information, profile data, shopping data, web analytics, etc., to enterprise server 722 for storage in database(s) 608.

It should be understood that system 700 illustrated in FIG. 7 is representative of an example system and that a variety of different system environments and configurations are contemplated and are within the scope of the present disclosure. For instance, various acts and/or functionality may be moved from a server to a client, or vice versa, data may be consolidated into a single data store or further segmented into additional data stores, and some implementations may include additional or fewer computing devices, services, and/or networks, and may implement various functionality client or server-side. Further, various entities of the system may be integrated into a single computing device or system or divided into additional computing devices or systems, etc.

Methods are described herein; however, it should be understood that the methods are provided by way of example, and that variations and combinations of these methods, as well as other methods, are contemplated. For example, in some embodiments, at least a portion of one or more of the methods represent various segments of one or more larger methods and may be concatenated or various steps of these methods may be combined to produce other methods which are encompassed by the present disclosure. Additionally, it should be understood that various operations in the methods may in some cases be iterative, and thus repeated as many times as necessary generate the results described herein. Further the ordering of the operations in the methods is provided by way of example and it should be understood that various operations may occur earlier and/or later in the method without departing from the scope thereof.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms such as “processing,” “computing,” “calculating,” “determining,” “displaying,” or the like, refer to the action and methods of a computer system that manipulates and transforms data represented as physical (electronic) quantities within the computer system's registers and memories into other data similarly represented as physical quantities within the computer system memories or registers or other such information storage, transmission or display devices.

A data processing system suitable for storing and/or executing program code, such as the computing system and/or devices discussed herein, may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices can be coupled to the system either directly or through intervening I/O controllers. The data processing system may include an apparatus may be specially constructed for the required purposes, or it may comprise a general-purpose computer selectively activated or reconfigured by a computer program stored in the computer.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects may not be mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. The technology can also take the form of a computer program product accessible from a computer-usable or computer-readable medium providing program code for use by or in connection with a computer or any instruction execution system. Wherever a component, an example of which is a module or engine, of the specification is implemented as software, the component can be implemented as a standalone program, as part of a larger program, as a plurality of separate programs, as a statically or dynamically linked library, as a kernel loadable module, as firmware, as resident software, as microcode, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A method executable by one or more computing devices, the method comprising:
receiving data for a plurality of items;
differentiating a first set of items of the plurality of items from a second set of items of the plurality of items based on the data, the first set of items having good data and the second set of items having bad data, good data indicated by a prediction accuracy metric of the good data being below a threshold, bad data indicated by the prediction accuracy metric of the bad data being above the threshold;
generating a first model for predicted demand levels of the first set of items, wherein the first model excludes cross-cluster effects with the second set of items;
generating a second model for predicted demand levels of the second set of items, wherein the second model includes a residual correction;
fitting at least one cluster-level regression model to estimate model coefficients associated with the first model and the second model;
generating a predicted demand of a particular item of the plurality of items based on the at least one cluster-level regression model and at least one of the first model and the second model.

2. The method of claim 1, wherein receiving data for the plurality of items comprises:
receiving a sales vector for the plurality of items over a defined period of time; and
receiving a matrix of item features for the plurality of items over the defined period of time.

3. The method of claim 1, wherein differentiating the first set of items from the second set of items based on the data comprises using a decentralized model to calculate weighted mean average percentage error (MAPE) values for the plurality of items at item-level as the prediction accuracy metric.

4. The method of claim 1, further comprising:
clustering the plurality of items using a clustering algorithm to assign the plurality of items to a plurality of item clusters;
generating in-cluster indicators for the plurality of items in each of the plurality of item clusters; and
generating cross-cluster indicators for the plurality of items in each of the plurality of item clusters.

5. The method of claim 1, wherein:
generating the first model comprises:
selectively removing at least one term that includes cross cluster effects; and
fitting at least one item-level correction model for the first set of items; and
generating the second model includes fitting at least one item-level correction model for the second set of items, wherein the at least one item-level correction model includes in-cluster features.

6. The method of claim 1, wherein:
generating the first model comprises using a decentralized model to calculate prediction accuracy metric values for the plurality of items at item-level;
fitting at least one cluster-level regression model comprises selectively removing at least one term that includes cross cluster effects; and
generating the second model includes fitting at least one item-level correction model for the second set of items, wherein the at least one item-level correction model includes in-cluster features.

7. The method of claim 1, wherein:
the first model, the second model, and the at least one cluster-level regression model include a plurality of coefficients estimated through regression-based fitting; and
generating the predicted demand of the particular item of the plurality of items comprises:
recovering the plurality of coefficients estimated for the particular item; and
calculating a predication accuracy value for the particular item.

8. The method of claim 1, further comprising:
receiving a proposed promotion associated with the particular item from the plurality of items; and
displaying the predicted demand of the particular item on a graphical user interface.

9. The method of claim 8, wherein displaying the predicted demand of the particular item for the proposed promotion includes displaying a profitability value associated with the proposed promotion over a defined period of time.

10. The method of claim 9, wherein displaying the predicted demand of the particular item for the proposed promotion includes displaying at least one profitability factor including baseline, uplift, discount, vendor fund, cannibalization, pull forward, halo effect, or total increase.

11. A system, comprising:
one or more processors;
one or more memories;
a sales data source comprising data for a plurality of items; and
a clustering analysis engine stored in the one or more memories and executable by the one or more processors for operations comprising:
differentiating a first set of items of the plurality of items from a second set of items of the plurality of items based on the data, the first set of items having good data and the second set of items having bad data, good data indicated by a prediction accuracy metric of the good data being below a threshold, bad data indicated by the prediction accuracy metric of the bad data being above the threshold;
generating a first model for predicted demand levels of the first set of items, wherein the first model excludes cross-cluster effects with the second set of items;
generating a second model for predicted demand levels of the second set of items, wherein the second model includes a residual correction;
fitting at least one cluster-level regression model to estimate model coefficients associated with the first model and the second model;
generating a predicted demand of a particular item of the plurality of items based on the at least one cluster-level regression model and at least one of the first model and the second model.

12. The system of claim 11, wherein the clustering analysis engine is further executable for operations comprising:
generating a sales vector for the plurality of items over a defined period of time; and
generating a matrix of item features for the plurality of items over the defined period of time, wherein the clustering analysis engine uses the sales vector and the matrix of item feature to generate the first model and the second model.

13. The system of claim 11, wherein the clustering analysis engine uses a decentralized model to calculate weighted mean average percentage error (MAPE) values for the plurality of items at item-level as the prediction accuracy metric used to differentiate the first set of items from the second set of items.

14. The system of claim 11, wherein the clustering analysis engine is further executable for operations comprising:
clustering the plurality of items using a clustering algorithm to assign the plurality of items to a plurality of item clusters;
generating in-cluster indicators for the plurality of items in each of the plurality of item clusters; and
generating cross-cluster indicators for the plurality of items in each of the plurality of item clusters.

15. The system of claim 11, wherein the clustering analysis engine:
generates the first model by selectively removing at least one term that includes cross cluster effects and fitting at least one item-level correction model for the first set of items; and
generates the second model by fitting at least one item-level correction model for the second set of items, wherein the at least one item-level correction model includes in-cluster features.

16. The system of claim 11, wherein the clustering analysis engine:
generates the first model using a decentralized model to calculate prediction accuracy metric values for the plurality of items at item-level;
fits at least one cluster-level regression model by selectively removing at least one term that includes cross cluster effects; and
generates the second model by fitting at least one item-level correction model for the second set of items, wherein the at least one item-level correction model includes in-cluster features.

17. The system of claim 11, wherein:
the first model, the second model, and the at least one cluster-level regression model include a plurality of coefficients estimated through regression-based fitting; and
the clustering analysis engine generates the predicted demand of the particular item of the plurality of items by recovering the plurality of coefficients estimated for the particular item and calculating a predication accuracy value for the particular item.

18. The system of claim 11, further comprising:
an input device, wherein a proposed promotion associated with the particular item from the plurality of items is input through the input device; and
an output device, wherein the output device is configured to display the predicted demand of the particular item on a graphical user interface.

19. The system of claim 18, wherein the predicted demand displayed on the graphical user interface includes a profitability value associated with the proposed promotion over a defined period of time.

20. The system of claim 18, wherein the predicted demand displayed on the graphical user interface includes at least one profitability factor including baseline, uplift, discount, vendor fund, cannibalization, pull forward, halo effect, or total increase.

21. A method executable by one or more computing devices, the method comprising:
receiving data for a plurality of items;
differentiating a first set of items of the plurality of items from a second set of items of the plurality of items based on the data, the first set of items having good data and the second set of items having bad data, good data indicating a prediction accuracy metric of the data being below a threshold, bad data indicating the prediction accuracy metric of the data being above the threshold;
generating a model for determining a predicted demand level of at least one item of the second set of items using the good data for the first set of items;
fitting a cluster-level demand model of the one or more items using item-level attributes shared by one or more of the plurality of items; and
generating a predicted demand of a particular item of the plurality of items based on the cluster-level demand model.
